(19) United States
(12) Patent Application Publication
(10) Pub. No.: US 2015/0287092 A1
(43) Pub. Date: Oct. 8, 2015

(54) SOCIAL NETWORKING CONSUMER PRODUCT ORGANIZATION AND PRESENTATION APPLICATION

(71) Applicants: Anthony SAMADANI, Hawthorne, CA (US); Varun BANSAL, IN (IN); Ali LANDRY, Los Angeles, CA (US); Michelle LUBA, Leesburg, VA (US)

(72) Inventors: Anthony SAMADANI, Hawthorne, CA (US); Varun BANSAL, IN (IN); Ali LANDRY, Los Angeles, CA (US); Michelle LUBA, Leesburg, VA (US)

(73) Assignee: FAVORED.BY, Studio City, CA (US)

(21) Appl. No.: 14/680,190

(22) Filed: Apr. 7, 2015

Related U.S. Application Data
(60) Provisional application No. 61/976,054, filed on Apr. 7, 2014.

(51) Int. Cl. G06Q 30/02; G06Q 50/00; G06F 17/30

(52) U.S. Cl. CPC G06Q 30/0269; G06F 17/30867; G06Q 50/01

(57) ABSTRACT

A user account may have various attributes which define the user personally. The attributes may be applied to product information of other users so the favorite products of various users with similar attributes can be shared automatically. One example method of operation may include identifying user profile attributes of a first user profile, comparing the user profile attributes to other user profile attributes of other user profiles to identify flagged products of interest by each of the other user profiles, comparing the flagged products associated with the other user profile attributes to identify a minimum relevancy threshold between the user profile attributes and the other user profile attributes, and updating a first data feed of the first user profile with the flagged products that are associated with other user profiles attributes which are above the minimum relevancy threshold as compared to a weighted sum of the user profile attributes of the first user profile.

### CROSS-REFERENCE TO RELATED APPLICATIONS

This application claims priority to earlier filed provisional patent application Ser. No. 61/976,054, filed on Apr. 7, 2014 and entitled SOCIAL NETWORKING CONSUMER PRODUCT ORGANIZATION AND PRESENTATION APPLICATION, the entire contents of which are hereby incorporated by reference.

### TECHNICAL FIELD OF THE APPLICATION

This application relates to a user accessible online social networking application that provides product listings and corresponding information based on popularity and other related categorization functions.

### BACKGROUND OF THE APPLICATION

Conventionally, online social networking platforms permit users to observe and share information. The information shared may include anything the user desires to post on his or her personal dashboard, homepage, etc. The information shared is not verified, quantified or measured against any reliable algorithm to ensure the information is valid or is based on a majority of user opinions or interests. The arbitrary nature of social networking websites and applications keep users entertained, however, the notion of accurate and organized information remains limited. Without ranking and prioritizing the information observed by users, social networking data sharing will remain as an entertainment platform with little if any useful functions.

### SUMMARY OF THE APPLICATION

One example embodiment may provide a method of comparing user attributes to other users' attributes to identify products which are most relevant and which are ranked according to a minimum relevancy threshold. The products can then be updated in the user interface, which are most relevant to the user based on the user attributes.

Another example embodiment may include a method that includes identifying user profile attributes of a first user profile, comparing the user profile attributes to other user profile attributes of other user profiles to identify flagged products of interest by each of the other user profiles, comparing the flagged products associated with the other user profile attributes to identify a minimum relevancy threshold between the user profile attributes and the other user profile attributes, and updating a first data feed of the first user profile with the flagged products that are associated with other user profiles attributes which are above the minimum relevancy threshold as compared to a weighted sum of the user profile attributes of the first user profile.

Another example embodiment may include an apparatus that includes a receiver configured to receive user profile attributes, and a processor configured to identify user profile attributes of a first user profile, compare the user profile attributes to other user profile attributes of other user profiles to identify flagged products of interest by each of the other user profiles, compare the flagged products associated with the other user profile attributes to identify a minimum relevancy threshold between the user profile attributes and the other user profile attributes, and update a first data feed of the first user profile with the flagged products that are associated with other user profiles attributes which are above the minimum relevancy threshold as compared to a weighted sum of the user profile attributes of the first user profile.

### BRIEF DESCRIPTION OF THE DRAWINGS

FIG. 1 illustrates an example application user interface according to example embodiments of the present application.

FIG. 2 illustrates an example data logic diagram of user profile information applied to product organization and presentation according to example embodiments of the present application.

FIG. 3 illustrates an example data flow logic diagram configuration of user profile and preference information being applied to product organization and corresponding calculation operations according to example embodiments of the present application.

FIG. 4A illustrates an example data retrieval and configuration setup according to example embodiments of the present application.

FIG. 4B illustrates an example data retrieval and results category based on user settings according to example embodiments of the present application.

FIG. 5 illustrates an example data logic flow diagram configuration according to example embodiments of the present application.

FIG. 6 illustrates an example system configured to perform the operations according to example embodiments of the present application.

FIG. 7 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

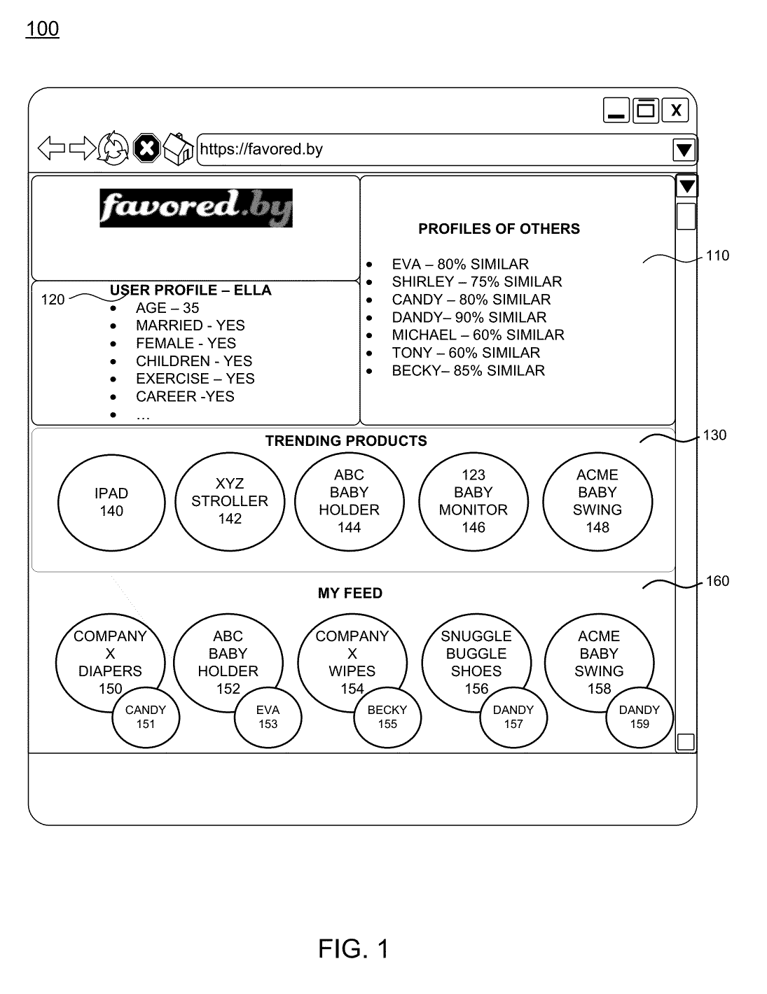

FIG. 1 illustrates an example application user interface according to example embodiments of the present application. In the present example user interface 100, the website or application portal may provide a series of information selection and viewing options related to consumer products. A user profile 120 may be setup based on common information, such as age, marital status, income level, career, children, etc. The profile 120 may also include other types of information, such as favorite product categories, favorite entertainment examples, favorite activities, etc. Once the user profile is setup, it may be applied to rank categories of products the user may find desirable.

According to example embodiments, the user may be accessing the present application and browsing the various categories of products in an effort to identify a product of interest. In one example, the user searches for a particular product, utilizing the existing filter function to limit the number of options available and to identify a more relevant product. When the user finds a product of interest, that product will have a particular product category and sub-category (e.g., baby products—strollers). The user may then identify and favor a single product per each sub-category to increase the relevancy of the search results. Each of the favorites selected per each user account become part of the user's unique electronic fingerprint which uniquely identifies the user and matches the user against other similar like-minded users for product sharing relevancy and other cross-referencing purposes described throughout the disclosure.

Once a product is favored by the user or designated as a favorite, the user may then explain in detail why this product is their favorite, by entering a description of the product's usage, usability, quality, etc., and/or using pre-existing menu options that provide a predetermined description corresponding to the user's selection. A menu option may be automatically generated and the text may be inserted depending on the user's choices and to permit the user to add his or her own comments. That favorite product selected may be received by the application and reported in more than one section of the application and its corresponding network including, but not limited to the trending feed, the user's homepage, the pages of each of the user's followers, etc. Other options available to cross-reference with the favored product may include the user's profile, the trending page, the “my feeds” page for followers of the user and/or in the notifications center for followers of the user. All favorites may be viewed by others in each of the areas above, automatically providing them an importance ranking that is visible beyond a mere addition, such as a “like” as provided in FACEBOOK®. The favorite selection is then forwarded to a product database which is processed by filters and used for matching to other users or recommending products. The ‘favorite’ selection is used to automatically rank products as they are viewed on the application in an order of what is the most favored product.

The profiles of others 110 may provide a basis for matching certain persons who participate in the application database and may provide the basis for person-to-person comparisons (i.e., like-mindedness), which may be a filter or preference for product information sharing. Also, the like-minded results may be based on percentages of relevancy between one user profile and another user profile. In this example, the various users are identified by name and each have a computed percentage that is a measurement of similarity to the present user ‘Ella’. Some users rank higher than others in terms of commonalities and product selection behavior and may be considered like-minded for purposes of sharing information.

In general, there are two main product feeds in the application where dynamic product listings are updated in real-time. The first feed is trending products 130, which represents the community at-large of all participants in the particular community and their selected ‘favorite’ products for a particular product category. The most popularly selected, liked and/or favored products for each of the users are identified and listed in order of most popular first. In this example, among the various users, the IPAD 140, the XYZ Co. baby stroller 142, the ABC baby holder 144, the 123 baby monitor 146 and the ACME baby swing 146 are all the most popular products for a particular category (e.g., Baby Products). Any user may have a favorite product in any category and/or sub-category, such as category ‘Baby Products’ and sub-category ‘Strollers’. A user may have a favored or favorite product in any of the large array of sub-categories, however, for purposes of this application, a user must select a favorite product for that sub-category. Each of the user's selections are compiled together to select the most sub-category selections in each category as illustrated in 130.

Alternatively, the user may observe product listings in the ‘my feed’ section 160. The user may observe postings and products selected and favored by each of the user's friends, followers, and/or followed persons, etc. In this feed, the products each have a corresponding user associated with the product based on the user's favorite selections. For example, a first product in the user's feed 160 may be a diaper company ‘X’ 150 that is personally favored by user Candy 151. The other products may include an ABC Co. baby holder favored by user ‘Eva’ 153, baby wipes by Co. ‘X’ 154 favored by user Becky 155, Snuggle Buggle shoes 156 favored by Dandy 157 and a baby swing by ACME company 158 favored by Dandy 159. The user activity in the user feed 160 may be based on the most recent activity or the most popular products by all members of the followed/following community.

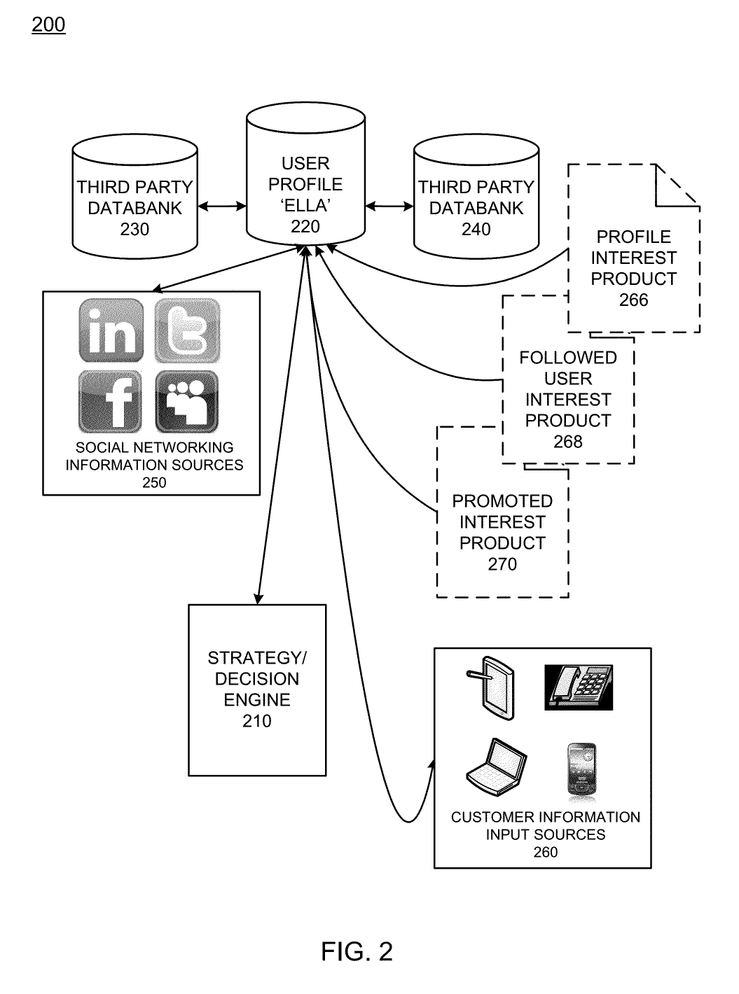

FIG. 2 illustrates an example data logic diagram of user profile information applied to product organization and presentation according to example embodiments of the present application. Referring to FIG. 2, the data information sources may include a user profile for the user ‘Ella’ 220 accessing information from other third party databanks 230 and 240, including but not limited to merchant product websites, product review websites, etc. Also, the user's social networking account 250 may be integrated into the user profile data that is shared with a strategy and decision engine 210 that calculates one or more profile interest products 266 to share on the user's product feeds, a followed user interest product 268 of a followed user, a promoted interest product 270 of a third party promotion site, etc. The user information sources 260 may be any of a phone, smartphone, cell phone, computing device, etc.

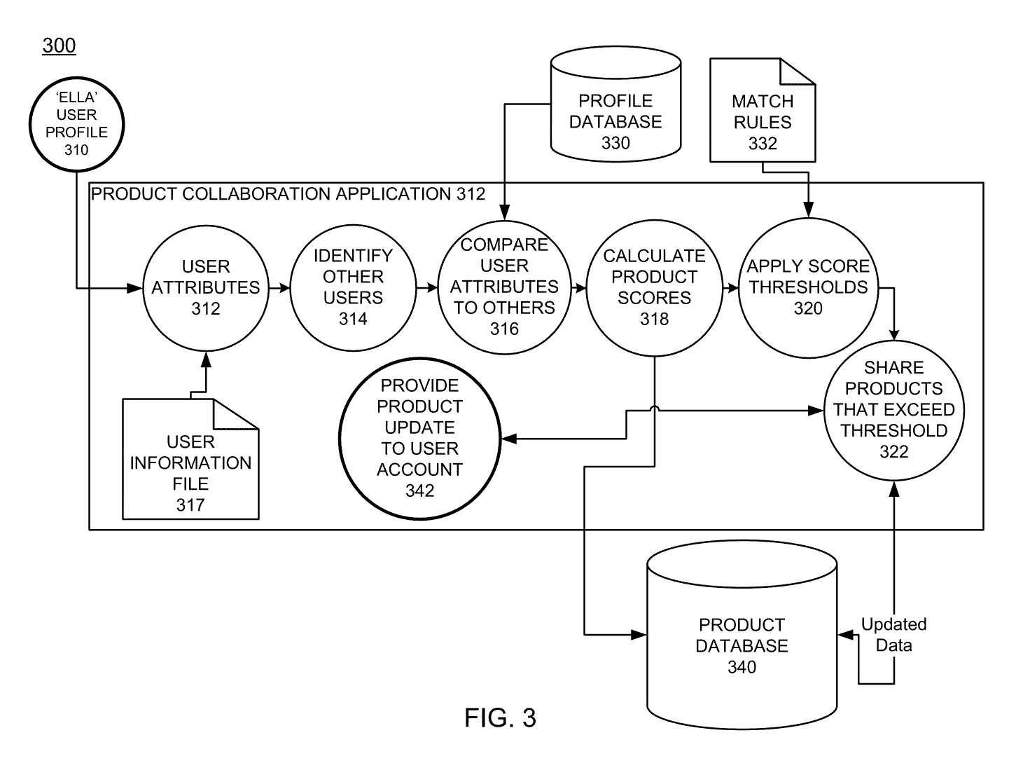

FIG. 3 illustrates an example data flow logic diagram configuration of user profile and preference information being applied to product organization and corresponding calculation operations according to example embodiments of the present application. Referring to FIG. 3, the diagram 300 includes a user profile 310 as a source of information that is used to identify user attributes 312 (e.g., profile data, interests, behavior, etc.) and to compare to other users 314 and their various attributes 316 retrieved from a remote databank 330 as part of the operations performed by the application 312. The user information file 317 may store a list of user information necessary to enable the user attributes to be retrieved and compared to the other user data of others and the corresponding products identified. The product scores can be calculated 318 to include user relevancy based on matching user profile to product metadata, other user relevancy based on other user profile data matched to the product metadata, etc.

The relevancy score may be based on a scale from 0 to 100% relevancy. A set of thresholds 320 may be setup and used to limit the results to a specific relevancy measure so the user is not provided too many results at a time or to ensure the rankings provide a prioritized list of products in descending order of popularity. The products that exceed or meet the established threshold may be shard 322 in the product feed or list in the user application 312. A product database 340 may be updated to include all products for all categories of interest. The product update can then be provided to the user account 342 to reflect all changes since the last update and so product categories are refreshed to reflect the most updated products only without older and less popular products.

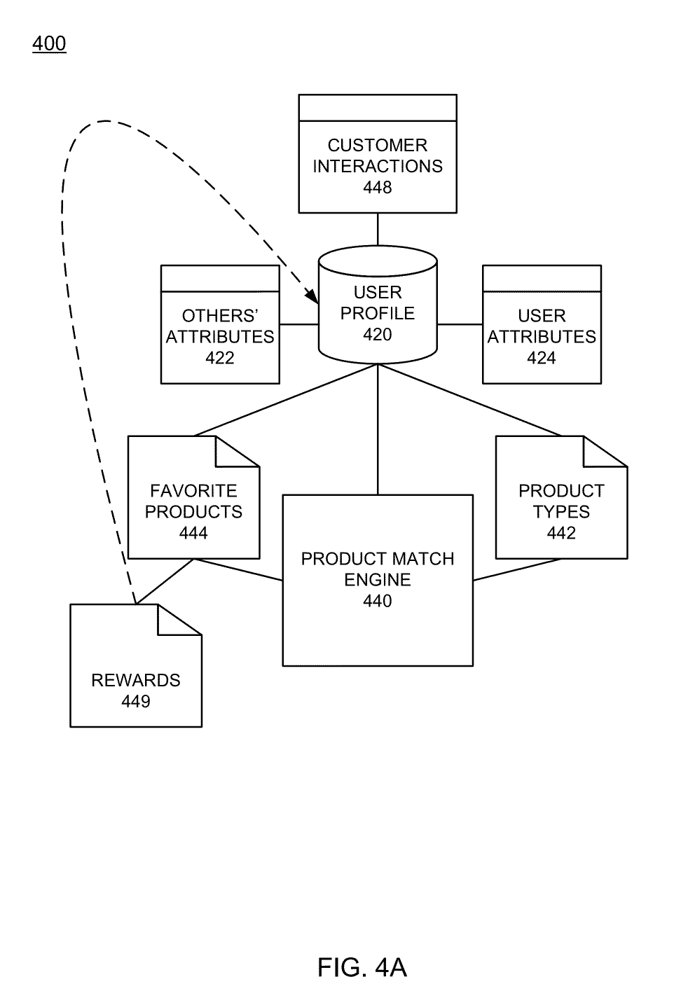

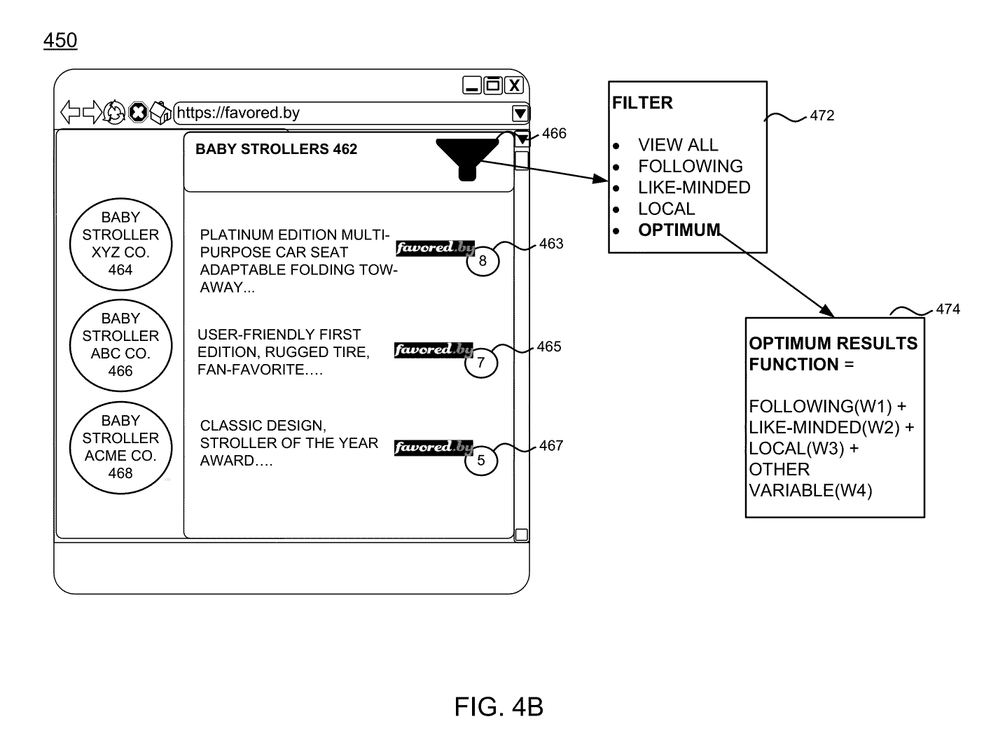

FIG. 4A illustrates an example data retrieval and configuration setup according to example embodiments of the present application. Referring to FIG. 4A, the logic 400 includes a user profile 420 as the source of various data attributes and transactions including customer interactions 448 with products and other users, attributes from other users 422, user attributes from the instant user 424 and currently selected favorite products 444 and the types of products 442 the user has favored or taken an interest in at the current time. The information can be received and used to match other products via the match engine 440 to share with the user at any given time in an particular category or sub-category. Also, the user's interactions and activities may be logged and used to create rewards 450 for favoring products to ensure the user is sharing his or her favorite items with others. The rewards may be coins, badges, points or other categories of rewards that can be obtained and updated in the user profile.

FIG. 4B illustrates an example data retrieval and results category based on user settings according to example embodiments of the present application. Referring to FIG. 4B, the example interface 450 includes a user product feed of products in a particular sub category ‘baby strollers’ 462. In this example, the filter function 466 may provide access to various product lists based on the user selected search criteria. For example, the baby stroller for XYZ Co. 464 may be the first and most favored product for the sub-category, the description 463 includes 8 users who favored this over all other products in the same sub-category. Second in the list is the ABC Co. baby stroller 466 with only 7 favors 465 followed by the ACME Co. stroller 468 with even less favors 467.

The filter 472 may include options to view all favored products from the entire database of favored products. The following option only permits the products to be ranked based on those users who the user is following or are following the user (e.g., friends of the user). Like-minded is a dynamic filter that seeks to provide results that are most relevant to the user based on similar users with similar interests and other user attributes. For example, the like-minded users may be people the user does not know but which are the closest in attributes, behavior, interests, to the user to provide a chance at sharing common interests among such users. The optimum interest may provide different results from all the other options by being based on a weighted function 474 of more than one category. For example, the function may include results filtered which are from the following category with a first predefined weight W1, such as 0.2 for the following users, a second predefined weight W2, such as 0.4 for the like-minded users, a third predefined weight W3, such as 0.2 for the local users and a last predefined weight W4, such as 0.2 for a different variable customized by the user. The results can now be weighted appropriately to provide the user with the best overall selection of products to save time and energy when trying to observe the best product for a particular user for a particular purpose.

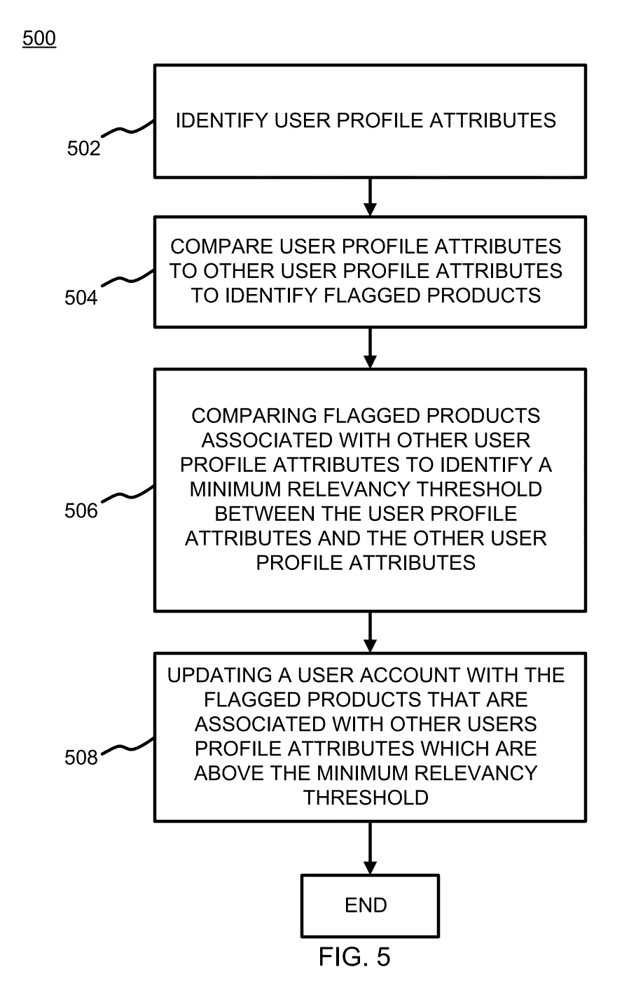

FIG. 5 illustrates an example data logic flow diagram 500 configuration according to example embodiments of the present application. Referring to FIG. 5, the user profile may be setup and accessed to retrieve information that is suitable for the user based on a particular selection algorithm. One example method of operation may include the use profile attributes being identified 502 and compared to other users' attributes to identify flagged products 504 which are currently popular in certain categories. The flagged products can then be identified against a minimum relevancy threshold setup to limit results to those which are relevant based on the minimum threshold requirement, which may be identified as a percentage of relevancy out of range of 0-100%, where the threshold may be for example %70 or higher. The user account can then be updated to share the flagged products which are relevant based on the user's attributes, and the minimum threshold value required.

Upon a user sign-up operation, the user profile may be created based on a series of questions which are stored in memory and weighted to provide an accurate profile for matching results. For instance, the quiz may include 12 questions with the first 3-4 questions being weighted higher than other questions. For example, the weights applied to questions, such as 1) male/female, 2) age range (5-10 year intervals), 3) relationship status (married, single, seeing someone long-term), 4) family status (kids vs. no kids), pregnant?, etc. The questions may each be weighted differently to provide like-minded matching with other user profiles. For example, the first question male/female may be weighted by as much as 25-30%. The second question, age may be weighted 20-25%, the same number of kids question may be weighted by only 20%, relationship status may be weighted by 10%, etc. Once the questions are answered the weights are applied according to a default algorithm or via user specified requests. For example, the user may be inclined to make the age range, income, or location question worth as much as 50% of the entire matching process. The weights are dynamically applied and may be modified based on a user preference. Another example may include cost analysis as a factor for users that desire the best value in price as the main objective, this option would put the best priced item much higher in any of the user feed categories or sub-categories if that was the primary objective of the user.

An example matching threshold may be a 65% match, for instance, this default threshold may be used to only share product pricing information with other users who match that particular user by 65% or more. This means all other users with less relevant percentages when compared to the main user will be disregarded and their favorite products will not be shared in the user's like-minded feed. However, their products may be shared in the most popular or trending product feeds depending on the user's options to only include like-minded results in those feeds as well or to include anyone. Secondary and less important questions, such as what do you do in your free time (sports, vs. reading)?, party preferences (night club vs. family gatherings)?, vacation preferences (Caribbean/mountains)?, food (American/foreign), etc. may only be as much as 5% of the user's profile, 50% may be another key threshold used to match 50% in other categories, such as popular items or trending items, or most popular items. When browsing products, such as strollers, the highest favored stroller will be placed on top of the user feed and the second less popular beneath the most popular.

One example embodiment may include a method that includes identifying user profile attributes of a first user profile, such as answers to questions and comparing the user profile attributes to other user profile attributes of other user profiles to identify flagged products of interest by each of the other user profiles. Those products may be favorite products selected by those other users and those other users may be relatively comparable to the original or first user by a minimum threshold percentage of similarities based on the profiles of such users. The method may also include comparing the flagged products associated with the other user profile attributes to identify a minimum relevancy threshold between the user profile attributes and the other user profile attributes, the minimum threshold may be 45% or more and as high as 85% relevant, and the method may also include updating a first data feed of the first user profile with the flagged products that are associated with other user profile attributes which are above the minimum relevancy threshold as compared to a weighted sum of the user profile attributes of the first user profile. The weighted sum may include a procedure for weighting the questions in the initial setup quiz to reflect a more accurate profile and to reduce the weights of less important questions and increase the weight of the more important questions.

This same example method may also provide creating a plurality of product feeds for each user profile, examples include trending products which are recently identified and popular on the product boards in general, most popular products which are favorited by the most members of the application, following products or those which are popular and favorited among users the user is following and like-minded products, which should provide the most relevant results of user profiles who are most like the instant user profile. Each of those feeds may have a unique threshold of relevancy to the instant users. For example, like-minded results may be the highest threshold of 65% or more relevancy, the trending and the most popular feeds may display products linked to the user profiles which are similar but have a lower relevancy, such as 50%. The following feed may have a relevancy that is lower since the user specific selected people to follow regardless of the likeness variables between their profiles.

The method continues with assigning a plurality of different minimum relevancy thresholds to each of the plurality of different product feeds, and populating the plurality of different product feeds of the first user profile with flagged products based on the plurality of different minimum relevancy thresholds. Also, populating the plurality of different product feeds with flagged products may be performed based on the plurality of different minimum relevancy thresholds includes identifying a plurality of minimum threshold levels for each of the plurality of different product feeds. The method also includes applying a plurality of different weights to each of the user profile attributes to create the first user profile having the weighted sum of the user profile attributes, and calculating the weighted sum based on each of the plurality of different weights. The method also includes identifying each of the user profiles, comparing the user profiles to the first user profile, filtering out all the user profiles which are below the minimum threshold value, and populating a plurality of user profile feeds associated with the first user profile with products associated with the user profiles which have not been filtered out.

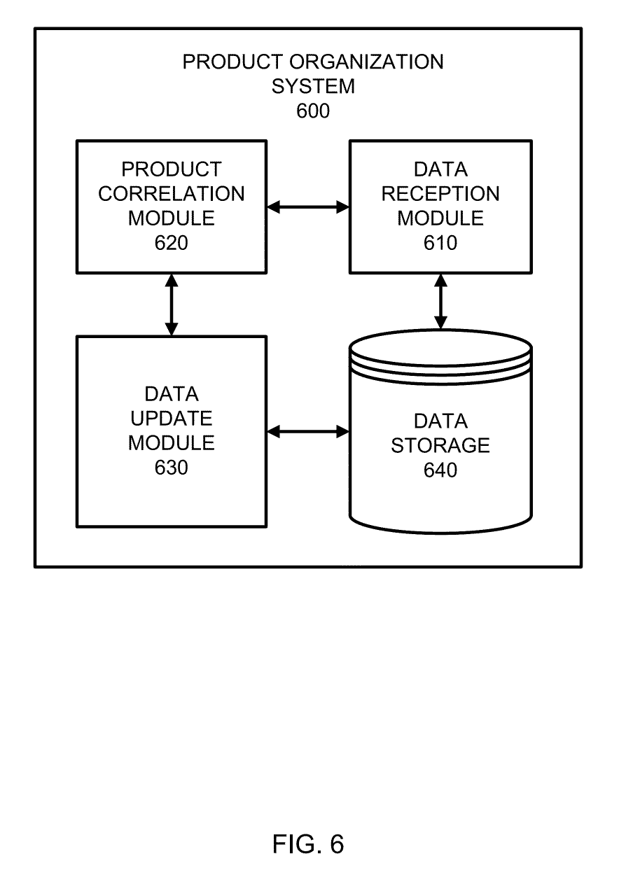

FIG. 6 illustrates an example system configured to perform the operations according to example embodiments of the present application. In FIG. 6, the system 600 may be a computer network device or entity that is responsible for organizing the product feeds and which includes a data reception module 610 of products currently trending and a product correlation module 620 of products which are similar or based on user profiles that correlate to the user profile being accessed. The data update module 630 may provide a way to modify the current product listings based on updated data received. The data storage 640 stores the updated data and updates the user feeds accordingly.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

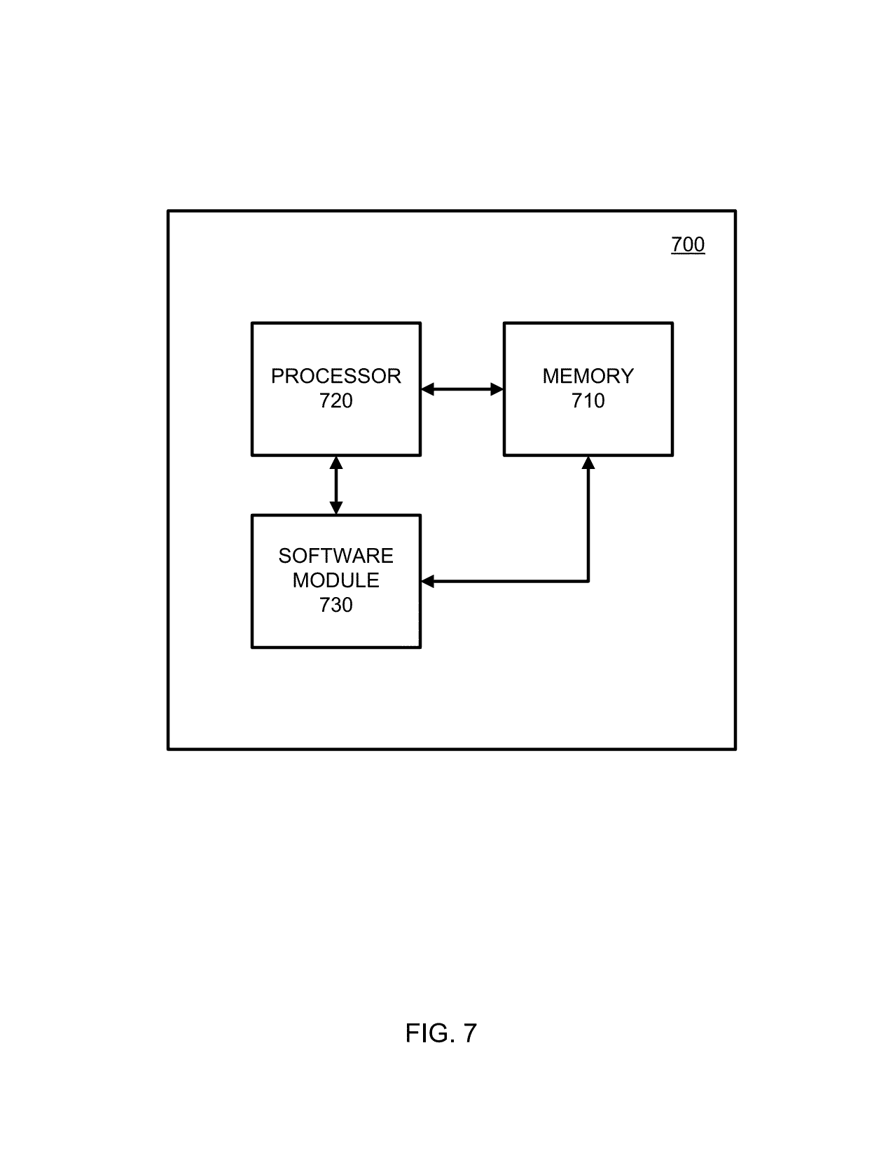

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 7 illustrates an example network element 700, which may represent any of the above-described network components, etc.

As illustrated in FIG. 7, a memory 710 and a processor 720 may be discrete components of the network entity 700 that are used to execute an application or set of operations. The application may be coded in software in a computer language understood by the processor 720, and stored in a computer readable medium, such as, the memory 710. The computer readable medium may be a non-transitory computer readable medium that includes tangible hardware components in addition to software stored in memory. Furthermore, a software module 730 may be another discrete entity that is part of the network entity 700, and which contains software instructions that may be executed by the processor 720. In addition to the above noted components of the network entity 700, the network entity 700 may also have a transmitter and receiver pair configured to receive and transmit communication signals (not shown).

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the system of FIG. 8 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
identifying user profile attributes of a first user profile;
comparing the user profile attributes to other user profile attributes of other user profiles to identify flagged products of interest by each of the other user profiles;
comparing the flagged products associated with the other user profile attributes to identify a minimum relevancy threshold between the user profile attributes and the other user profile attributes; and
updating a first data feed of the first user profile with the flagged products that are associated with other user profiles attributes which are above the minimum relevancy threshold as compared to a weighted sum of the user profile attributes of the first user profile.

2. The method of claim 1, further comprising:
creating a plurality of product feeds for each user profile;
assigning a plurality of different minimum relevancy thresholds to each of the plurality of different product feeds; and
populating the plurality of different product feeds of the first user profile with flagged products based on the plurality of different minimum relevancy thresholds.

3. The method of claim 1, wherein populating the plurality of different product feeds with flagged products based on the plurality of different minimum relevancy thresholds comprises identifying a plurality of minimum threshold levels for each of the plurality of different product feeds.

4. The method of claim 1, further comprising:
applying a plurality of different weights to each of the user profile attributes to create the first user profile having the weighted sum of the user profile attributes; and
calculating the weighted sum based on each of the plurality of different weights.

5. The method of claim 1, further comprising:
identifying each of the user profiles;
comparing the user profiles to the first user profile;
filtering out all the user profiles which are below the minimum threshold value; and
populating a plurality of user profile feeds associated with the first user profile with products associated with the user profiles which have not been filtered out.

6. An apparatus comprising:
a receiver configured to receive user profile attributes; and
a processor configured to
identify user profile attributes of a first user profile;
compare the user profile attributes to other user profile attributes of other user profiles to identify flagged products of interest by each of the other user profiles;
compare the flagged products associated with the other user profile attributes to identify a minimum relevancy threshold between the user profile attributes and the other user profile attributes; and
update a first data feed of the first user profile with the flagged products that are associated with other user profiles attributes which are above the minimum relevancy threshold as compared to a weighted sum of the user profile attributes of the first user profile.

7. The apparatus of claim 6, wherein the processor is further configured to
create a plurality of product feeds for each user profile,
assign a plurality of different minimum relevancy thresholds to each of the plurality of different product feeds, and
populate the plurality of different product feeds of the first user profile with flagged products based on the plurality of different minimum relevancy thresholds.

8. The apparatus of claim 6, wherein populating the plurality of different product feeds with flagged products based on the plurality of different minimum relevancy thresholds comprises identifying a plurality of minimum threshold levels for each of the plurality of different product feeds.

9. The apparatus of claim 6, wherein the processor is further configured to apply a plurality of different weights to each of the user profile attributes to create the first user profile having the weighted sum of the user profile attributes, and calculate the weighted sum based on each of the plurality of different weights.

10. The apparatus of claim 6, wherein the processor is further configured to
identify each of the user profiles;
compare the user profiles to the first user profile;
filter out all the user profiles which are below the minimum threshold value; and
populate a plurality of user profile feeds associated with the first user profile with products associated with the user profiles which have not been filtered out.

11. A non-transitory computer readable storage medium configured to store instructions that when executed cause a processor to perform:
identifying user profile attributes of a first user profile;
comparing the user profile attributes to other user profile attributes of other user profiles to identify flagged products of interest by each of the other user profiles;
comparing the flagged products associated with the other user profile attributes to identify a minimum relevancy threshold between the user profile attributes and the other user profile attributes; and
updating a first data feed of the first user profile with the flagged products that are associated with other user profiles attributes which are above the minimum relevancy threshold as compared to a weighted sum of the user profile attributes of the first user profile.

12. The non-transitory computer readable storage medium of claim 11, wherein the processor is further configured to perform:
creating a plurality of product feeds for each user profile;
assigning a plurality of different minimum relevancy thresholds to each of the plurality of different product feeds; and
populating the plurality of different product feeds of the first user profile with flagged products based on the plurality of different minimum relevancy thresholds.

13. The non-transitory computer readable storage medium of claim 12, wherein populating the plurality of different product feeds with flagged products based on the plurality of different minimum relevancy thresholds comprises identifying a plurality of minimum threshold levels for each of the plurality of different product feeds.

14. The non-transitory computer readable storage medium of claim 11, wherein the processor is further configured to
apply a plurality of different weights to each of the user profile attributes to create the first user profile having the weighted sum of the user profile attributes; and
calculate the weighted sum based on each of the plurality of different weights.

15. The non-transitory computer readable storage medium of claim 11, wherein the processor is further configured to perform:
identifying each of the user profiles;
comparing the user profiles to the first user profile;
filtering out all the user profiles which are below the minimum threshold value; and
populating a plurality of user profile feeds associated with the first user profile with products associated with the user profiles which have not been filtered out.
